(19) United States
(12) Patent Application Publication
(10) Pub. No.: US 2018/0033324 A1
(43) Pub. Date: Feb. 1, 2018

(54) DIGITAL DIARY EXCHANGE SYSTEM WITH A FRIEND-PAIRING FUNCTION

(71) Applicant: Hope Yuan-Jing Chung, Taichung City (TW)

(72) Inventor: Hope Yuan-Jing Chung, Taichung City (TW)

(21) Appl. No.: 15/652,611

(22) Filed: Jul. 18, 2017

(30) Foreign Application Priority Data
Jul. 26, 2016 (TW) 105123640

(51) Int. Cl. G09B 5/12; H04W 12/02; H04L 29/08; H04L 12/58; H04W 4/02

(52) U.S. Cl. CPC G09B 5/12; H04L 51/38; H04W 4/02; H04L 67/10; H04W 12/02

(57) ABSTRACT

A digital diary exchange system with a friend-pairing function includes a first terminal device, multiple second terminal devices and a server. The first terminal device receives a piece of first personal information. The server transmits a paired friend list according to the piece of first personal information. When the second terminal device receives a signal of consent, the server pairs a corresponding second terminal device with the first terminal device and performs a digital diary information exchange procedure for the first terminal device and the second terminal device paired with each other to exchange digital diary information. As such, a new corner can pair with a friend located at a corresponding second terminal device through the first terminal device and receives the consent from the second terminal device to exchange digital diary information, share learning experience, and increase learning aspiration and efficiency.

### BACKGROUND OF THE INVENTION

### 1.Field of the Invention

The present invention relates to an exchange system and, more particularly, to a digital diary exchange system with a friend-pairing function.

### 2. Description of the Related Art

Children usually learn from teachings conducted by teachers at schools through a subject chosen by teachers during the class for guiding children in the course of learning. For example, teachers may provide multiple storybooks or assign one storybook to children as the lecture subject for children to choose. During the class, teachers may explain content of the chosen or assigned storybook in collaboration with voice and action depending on the content to catch attention and facilitate comprehension of children. As a part of the lecture in the course of teaching, interspersed vocabularies of different languages can be joined as well. Thus, children can comprehend the content of the storybook and in the meantime learn vocabularies of other languages to effectively increase children's learning interest and deepen memory and effectiveness in learning.

Regular classes are conducted by professional teachers. Even though children in the class may not be commonly interested in a same storybook, sometimes, every child in the class can still learn the story provided by the teacher. However, the story assigned by the teacher may not attract all the children in the class. To those who are not interested in the assigned story, the learning effectiveness is inevitably low.

On the other hand, children's response toward teachings through teachers is also very important in terms of interactive learning. Some children are shy and timid and there may be a significant age gap between teachers and children, so that children may shy away from giving an opinion at class or directly get consultation from teachers after class. Such type of children is sensitive in approaching teachers or parents for help and is also reluctant to get the questions off their chests, and such mindset and hesitation oftentimes causes learning harrier.

### SUMMARY OF THE INVENTION

An objective of the present invention is to provide a digital diary exchange system with a friend-pairing function for users to pair with friends and exchange digital diary information mutually.

To achieve the foregoing objective, the digital diary exchange system with a friend-pairing function includes a first terminal device, multiple second terminal devices and a server.

The first terminal device receives a piece of first personal information and transmits the piece of first personal information out.

The server has a database with multiple pieces of person-pairing information stored in the database. Each piece of person-pairing information corresponds to one of the multiple second terminal devices. The server is connected to the first terminal device, receives the piece of personal information transmitted from the first terminal device, stores the piece of first personal information in the database, generates a paired friend list according to the piece of first personal information and the multiple pieces of person-pairing information, and transmits the paired friend list to the first terminal device. The paired friend list has at least one recommendation information and each one of the at least one recommendation information corresponds to one of the multiple pieces of person-pairing information.

The first terminal device receives the paired friend list and a choice confirmation signal and transmits the choice confirmation signal to the server.

The server selects one of the at least one recommendation information in the paired friend list according to the choice confirmation signal, and transmits a confirmation request signal according to the piece of person pairing information matching the selected piece of recommendation information to the second terminal device matching the piece of person pairing information;

The server determines if the matching second terminal device receives a signal of consent, when the matching second terminal device receives the signal of consent and transmits the signal of consent to the server, the server pairs the first terminal device with the matching second terminal device, and performs a digital diary information exchange procedure for the first terminal device and the second terminal device matching each other to exchange digital diary information.

Given the digital diary exchange system, a new corner can utilize the first terminal device for registration. Upon registration, the new corner inputs the piece of first personal information. The server then provides the paired friend list according to the piece of first personal information inputted by the new corner. The new corner can selects one of the at least one recommendation information in the paired friend list through the first terminal device. Thus, only the piece of recommendation information attracting the new corner or a congenial friend matching the piece of recommendation information will be selected. The new corner can go through the first terminal device to choose a preferred friend and transmits the confirmation request signal to a corresponding second terminal device for the selected friend to confirm consent. After the consent is confirmed, the new corner is paired with the selected friend, and transmits digital diary information to the second terminal device corresponding to the paired friend through the server for the second terminal device to read. Thus, the new corner can exchange digital diary information and storybooks of interest with paired friend for sharing learning experience and increasing learning aspiration and efficiency.

Additionally, as the paired friend is selected from the at least one recommendation information in the paired friend list, the paired friend is close to the need in terms of common interest and age. Therefore, children using the system enjoy the sharable learning experience without having the problem of learning barrier caused by shying away from teachers in discussion.

Other objectives, advantages and novel features of the invention will become more apparent from the following detailed description when taken in conjunction with the accompanying drawings.

### BRIEF DESCRIPTION OF THE DRAWINGS

FIG. 1 is a functional block diagram of a digital diary exchange system with a friend-pairing function in accordance with the present invention; and

FIG. 2 is a flow diagram of a digital diary information exchange procedure in accordance with the present invention.

### DETAILED DESCRIPTION OF THE INVENTION

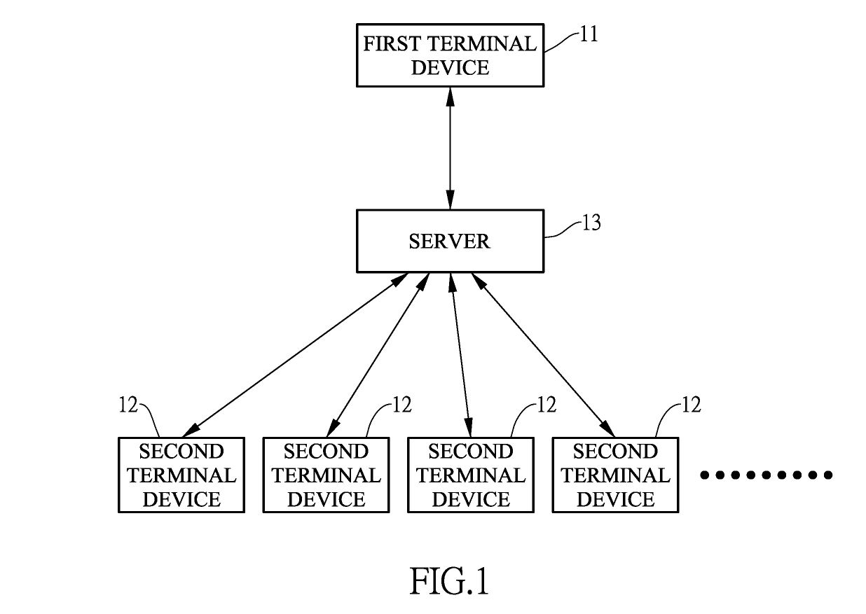

With reference to FIG. 1, a digital diary exchange system with a friend-pairing function in accordance with the present invention includes a first terminal device 11, multiple second terminal devices 12 and a server 13.

The first terminal device 11 receives a piece of first personal information and transmits the piece of first personal information out.

The server 13 has a database storing multiple pieces of person-pairing information therein with each piece of person-pairing information corresponding to one of the multiple second terminal devices 12.

The server 13 is connected to the first terminal device 11, receives the piece of first personal information transmitted from the first terminal device 11, stores the piece of first personal information in the database, generates a paired friend list according to the piece of first personal information and the multiple pieces of person-pairing information, and transmits the paired friend list to the first terminal device 11. The paired friend list includes at least one piece of recommendation information, and each piece of recommendation information corresponds to one of the multiple pieces of person pairing information.

The first terminal device 11 receives the paired friend list and a choice confirmation signal and transmits the choice confirmation signal to the server 13.

The server 13 selects one of the at least one piece of recommendation information according to the choice confirmation signal, and transmits a confirmation request signal according to the piece of person pairing information matching the selected piece of recommendation information to the second terminal device 12 matching the piece of person pairing information.

The server 13 determines if the matching second terminal device 12 receives a signal of consent. When the matching second terminal device 12 receives the signal of consent and transmits the signal of consent to the server 13, the server 13 pairs the first terminal device 11 with the matching second terminal device 12, and performs a digital diary information exchange procedure for the first terminal device 11 and the second terminal device 12 matching each other to exchange digital diary information.

In the present embodiment, the first terminal device 11 is connected to the server 13 through network connection, and the second terminal device 12 is connected to the server 13 through network connection.

Given the digital diary exchange system, a new corner can utilize the first terminal device 11 for registration. Upon registration, the new corner inputs the piece of first personal information. The server 13 then provides the paired friend list according to the piece of first personal information inputted by the new comer. The new corner can selects one of the at least one recommendation information in the paired friend list through the first terminal device 11. Thus, only the piece of recommendation information attracting the new corner or a congenial friend matching the piece of recommendation information will be selected.

The new coiner can go through the first terminal device 11 to choose a preferred friend and transmits the confirmation request signal to a corresponding second terminal device 12 for the selected friend to confirm consent. After the consent is confirmed, the selected friend is paired and mutual digital diary information can be exchanged to enhance learning efficacy.

In other words, after pairing with the selected friend, the new corner can upload self-recorded digital diary information for the paired friend to access, and the paired friend can also upload self-recorded digital diary information for the new corner to share. For example, the new corner can make the thought and learning experience gained from a chosen storybook of interest sharable with the paired friend as a way of learning together. Likewise, the paired friend may do the same to the new corner to further raise the learning effectiveness of the new comer.

In the present embodiment, each of the piece of first personal information and the multiple pieces of person-pairing information includes at least one hobby, an age, a sex gender and an address.

The address in the piece of first personal information and the multiple pieces of person-pairing information may be acquired by a global positioning system (GPS) or a WiFi (Wireless Fidelity) positioning system.

The digital diary exchange system generates the paired friend list according to the at least one hobby, the age, the sex gender and the address contained in the first personal information and the multiple pieces of person-pairing information stored in the database. Thus, each piece of person-pairing information with the at least one hobby, the age, the sex gender and the address matching those in the piece of first personal information is entered into the paired friend list as one of the multiple pieces of recommendation information for the new corner to choose. The new corner can select a paired friend on the basis of preference toward the at least one interest, the age, the sex gender and the address, and further transmit the confirmation request signal to the selected friend to ask if the selected friend is willing to be paired. Therefore, a paired friend with preferred interest, age, sex gender and address can be easily identified and the successfully paired new corner and paired friend can have more chance in exchanging idea about interested subjects, thereby sharing mutual learning experience and raising learning efficacy.

Given an example for explanation, when the paired friend list is generated, the at least one hobby in the piece of first personal information is compared with that in each piece of person-pairing information to identify if the piece of person-pairing information has at least one common interest as in the piece of first personal information. Furthermore, the age and the sex gender in the piece of first personal information are respectively compared with those in each piece of person-pairing information to identify if the piece of person-pairing information has identical age and sex gender as in the piece of person-pairing information. Then, a distance between the address in each piece of person-pairing information and that of the piece of first personal information is calculated, and the identified pieces of person-pairing information with at least one common interest and identical age and sex gender are listed in sequence based on a rising order of the distance and each identified piece of person-pairing information corresponds to one of the multiple pieces of recommendation information in generation of the paired friend list.

The multiple pieces of recommendation information in the paired friend list suggest multiple paired friends with common interest and identical age and sex gender for the new corner to easily identify. Besides, as the multiple pieces of recommendation information are listed according to the rising tendency of the distance, the new corner can easily identify any paired friend in the nearby and conveniently arrange an appointment for the new corner and the paired friend to meet and get acquainted.

Additionally, each of the piece of first personal information and the multiple pieces of person-pairing information includes a guardian request.

In view of young children with safety concern, each of the piece of first personal information and the multiple pieces of person-pairing information further includes guardian request information. When the paired friend list is generated, the guardian request information in each piece of recommendation information is checked and any piece of recommendation information not meeting the guardian request information is screened out to alleviate the concern of the guardian.

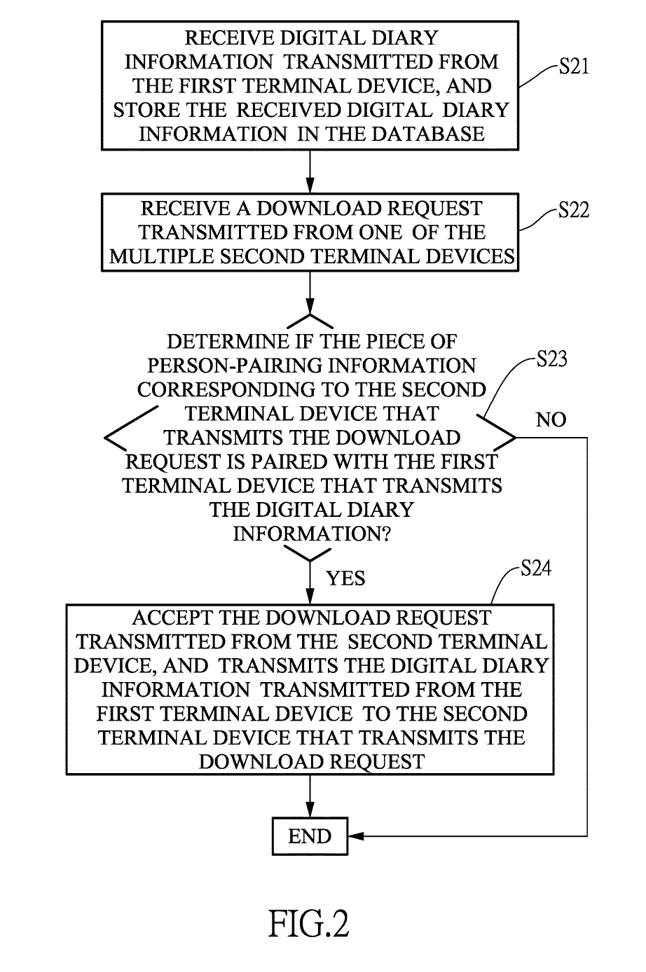

With respect to FIG. 2, a digital diary information exchange procedure performed by the server 13 of the digital diary exchange system in accordance with the present invention includes the following steps.

Step S21: Receive digital diary information transmitted from the first terminal device 11, and store the received digital diary information in the database.

Step S22: Receive a download request transmitted from one of the multiple second terminal devices 12.

Step S23: Determine if the piece of person-pairing information corresponding to the second terminal device 12 that transmits the download request is paired with the first terminal device 11 that transmits the digital diary information.

Step S24: When determining that the piece of person-pairing information corresponding to the second terminal device 12 that transmits the download request is paired with the first terminal device 11 that transmits the digital diary information, accept the download request transmitted from the second terminal device 12, and transmits the digital diary information transmitted from the first terminal device 11 to the second terminal device 12 that transmits the download request.

By virtue of the steps of the digital diary information exchange procedure, the new corner can exchange digital diary information with paired friend for sharing learning experience and increasing learning aspiration and efficiency.

Even though numerous characteristics and advantages of the present invention have been set forth in the foregoing description, together with details of the structure and function of the invention, the disclosure is illustrative only. Changes may he made in detail, especially in matters of shape, size, and arrangement of parts within the principles of the invention to the full extent indicated by the broad general meaning of the terms in which the appended claims are expressed.

What is claimed is:

1. A digital diary exchange system with a friend-pairing function, comprising:
a first terminal device receiving a piece of first personal information and transmitting the piece of first personal information out;
multiple second terminal devices;
a server having a database with multiple pieces of person-pairing information stored in the database, wherein each piece of person-pairing information corresponds to one of the multiple second terminal devices, wherein the server is connected to the first terminal device, receives the piece of personal information transmitted from the first terminal device, stores the piece of first personal information in the database, generates a paired friend list according to the piece of first personal information and the multiple pieces of person-pairing information, and transmits the paired friend list to the first terminal device, wherein the paired friend list has at least one recommendation information and each one of the at least one recommendation information corresponds to one of the multiple pieces of person-pairing information;
wherein the first terminal device receives the paired friend list and a choice confirmation signal and transmits the choice confirmation signal to the server;
wherein the server selects one of the at least one recommendation information in the paired friend list according to the choice confirmation signal, and transmits a confirmation request signal according to the piece of person pairing information matching the selected piece of recommendation information to the second terminal device matching the piece of person pairing information;
wherein the server determines if the matching second terminal device receives a signal of consent, when the matching second terminal device receives the signal of consent and transmits the signal of consent to the server, the server pairs the first terminal device with the matching second terminal device, and performs a digital diary information exchange procedure for the first terminal device and the second terminal device matching each other to exchange digital diary information.

2. The digital diary exchange system as claimed in claim 1, wherein each of the piece of first personal information and the multiple person-pairing information has at least one hobby, an age, a sex gender and an address.

3. The digital diary exchange system as claimed in claim 2, wherein the address in the piece of first personal information and the multiple pieces of person-pairing information is acquired by a global positioning system (GPS) or a WiFi (Wireless Fidelity) positioning system.

4. The digital diary exchange system as claimed in claim 3, wherein the paired friend list is generated by the server according to steps of:
comparing the at least one hobby, the age and the sex gender in the piece of first personal information with the at least one hobby, the age and the sex gender in each piece of person-pairing information to identify the piece of person-pairing information with the at least one hobby, the age and the sex gender identical to the at least one hobby, the age and the sex gender of the piece of first personal information; and
calculating a distance between the address in each identified piece of person-pairing information and the address in the piece of first personal information, and listing the identified piece of person-pairing information according to a rising order of the distance, wherein each identified piece of person-pairing information corresponds to one of the multiple recommendation information to generate the paired friend list.

5. The digital diary exchange system as claimed in claim 2, wherein each of the piece of first personal information and the multiple pieces of person-pairing information further includes guardian request information, and when the paired friend list is generated, each piece of recommendation information is screened out according to the guardian request information contained therein.

6. The digital diary exchange system as claimed in claim 3, wherein each of the piece of first personal information and the multiple pieces of person-pairing information further includes guardian request information, and when the paired friend list is generated, each piece of recommendation information is screened out according to the guardian request information contained therein.

7. The digital diary exchange system as claimed in claim 1, wherein the digital diary information exchange procedure includes steps of:
receiving digital diary information transmitted from the first terminal device, and storing the received digital diary information in the database;
receiving a download request transmitted from one of the multiple second terminal devices;
determining if the piece of person-pairing information corresponding to the second terminal device that transmits the download request is paired with the first terminal device that transmits the digital diary information; and
when determining that the piece of person-pairing information corresponding to the second terminal device that transmits the download request is paired with the first terminal device that transmits the digital diary information, accepting the download request transmitted from the second terminal device, and transmitting the digital diary information transmitted from the first terminal device to the second terminal device that transmits the download request.

8. The digital diary exchange system as claimed in claim 2, wherein the digital diary information exchange procedure includes steps of
receiving digital diary information transmitted from the first terminal device, and storing the received digital diary information in the database;
receiving a download request transmitted from one of the multiple second terminal devices;
determining if the piece of person-pairing information corresponding to the second terminal device that transmits the download request is paired with the first terminal device that transmits the digital diary information; and
when determining that the piece of person-pairing information corresponding to the second terminal device that transmits the download request is paired with the first terminal device that transmits the digital diary information, accepting the download request transmitted from the second terminal device, and transmitting the digital diary information transmitted from the first terminal device to the second terminal device that transmits the download request.

9. The digital diary exchange system as claimed in claim 3, wherein the digital diary information exchange procedure includes steps of:
receiving digital diary information transmitted from the first terminal device, and storing the received digital diary information in the database;
receiving a download request transmitted from one of the multiple second terminal devices;
determining if the piece of person-pairing information corresponding to the second terminal device that transmits the download request is paired with the first terminal device that transmits the digital diary information; and
when determining that the piece of person-pairing information corresponding to the second terminal device that transmits the download request is paired with the first terminal device that transmits the digital diary information, accepting the download request transmitted from the second terminal device, and transmitting the digital diary information transmitted from the first terminal device to the second terminal device that transmits the download request.

10. The digital diary exchange system as claimed in claim 4, wherein the digital diary information exchange procedure includes steps of:
receiving digital diary information transmitted from the first terminal device, and storing the received digital diary information in the database;
receiving a download request transmitted from one of the multiple second terminal devices;
determining if the piece of person-pairing information corresponding to the second terminal device that transmits the download request is paired with the first terminal device that transmits the digital diary information; and
when determining that the piece of person-pairing information corresponding to the second terminal device that transmits the download request is paired with the first terminal device that transmits the digital diary information, accepting the download request transmitted from the second terminal device, and transmitting the digital diary information transmitted from the first terminal device to the second terminal device that transmits the download request.

11. The digital diary exchange system as claimed in claim 5, wherein the digital diary information exchange procedure includes steps of:
receiving digital diary information transmitted from the first terminal device, and storing the received digital diary information in the database;
receiving a download request transmitted from one of the multiple second terminal devices;
determining if the piece of person-pairing information corresponding to the second terminal device that transmits the download request is paired with the first terminal device that transmits the digital diary information; and
when determining that the piece of person-pairing information corresponding to the second terminal device that transmits the download request is paired with the first terminal device that transmits the digital diary information, accepting the download request transmitted from the second terminal device, and transmitting the digital diary information transmitted from the first terminal device to the second terminal device that transmits the download request.

12. The digital diary exchange system as claimed in claim 6, wherein the digital diary information exchange procedure includes steps of:
receiving digital diary information transmitted from the first terminal device, and storing the received digital diary information in the database;
receiving a download request transmitted from one of the multiple second terminal devices;
determining if the piece of person-pairing information corresponding to the second terminal device that transmits the download request is paired with the first terminal device that transmits the digital diary information; and
when determining that the piece of person-pairing information corresponding to the second terminal device that transmits the download request is paired with the first terminal device that transmits the digital diary information, accepting the download request transmitted from the second terminal device, and transmitting the digital diary information transmitted from the first terminal device to the second terminal device that transmits the download request.
